(19) United States
(12) Patent Application Publication
(10) Pub. No.: US 2008/0104672 A1
(43) Pub. Date: May 1, 2008

(54) DETECTING AND PREVENTING MAN-IN-THE-MIDDLE PHISHING ATTACKS

(75) Inventors: Ron Lunde, Portland, OR (US); Scott Franklin, Portland, OR (US); Daniel Lulich, Portland, OR (US); Greg Pierson, Woodland, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: IOVATION, INC., Portland, OR (US)

(21) Appl. No.: 11/923,561

(22) Filed: Oct. 24, 2007

Related U.S. Application Data
(60) Provisional application No. 60/862,946, filed on Oct. 25, 2006.

(51) Int. Cl. G06F 7/04

(52) U.S. Cl. 726/3

(57) ABSTRACT

Embodiments of the present invention provide methods, servers and articles of manufacture that detect and prevent man-in-the-middle phishing attacks. This includes receiving device-specific information from a client device at a fraud prevention server, appending at least one of an internet protocol (IP) address and/or a timestamp to the device-specific information, and forwarding the appended device-specific information back to the client device for providing to an network service server for use by the network service server to facilitate recognition of the client device via at least one of the IP address and/or the timestamp.

### CROSS REFERENCE TO RELATED APPLICATIONS

The present application claims priority to U.S. Patent Application No. 60/862,946, filed Oct. 25, 2006, entitled “Detecting and Preventing Man-In-The-Middle Phishing Attacks,” the entire specification of which is hereby incorporated by reference in its entirety for all purposes, except for those sections, if any, that are inconsistent with this specification.

### TECHNICAL FIELD

Embodiments of the present invention relate to the field of data processing, and more particularly, to the detection and prevention of static and/or dynamic man-in-the-middle phishing attacks during computer network transactions.

### BACKGROUND

Advances in microprocessor technologies have made computing ubiquitous. Advances in networking and telecommunication technologies have also made computing increasingly networked. Today, huge volumes of content and services are available through interconnected public and/or private networks. Ironically, the ubiquitous availability of computing has also led to abuses, such as denial of service attacks, viruses, spam, and phishing.

In a typical “phishing” scam, an end user is tricked into entering their account name and password into a site that looks identical to a legitimate site. The attacker then captures the login information and often redirects the user to the actual site so that it appears that they have simply mistyped their password.

This type of attack may be prevented by several techniques, including the use of one-time passwords, so that each login attempt is unique, and uses something that only the legitimate user would know. Unfortunately, none of these methods works against a “dynamic proxy” attack in which the information is simply passed through a server in the middle in both directions. To a bank or a service provider it appears they are directly connected to the user, while to the user it appears they are directly connected to the legitimate site, but the “man-in-the-middle” attacker can hijack the session or inject extra commands into the session. The simplest approach for the man-in-the-middle is to simply not log out when the user does, and then issue other requests, such as to view balances or transfer money.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates a computer system, in accordance with various embodiments of the present invention;

FIGS. 2A and 2B. schematically illustrates a computer network for use to practice various embodiments of the present invention; and

FIG. 3 is a flow chart describing operations, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide methods, servers and articles of manufacture that are directed to detection and prevention of man-in-the-middle phishing attacks.

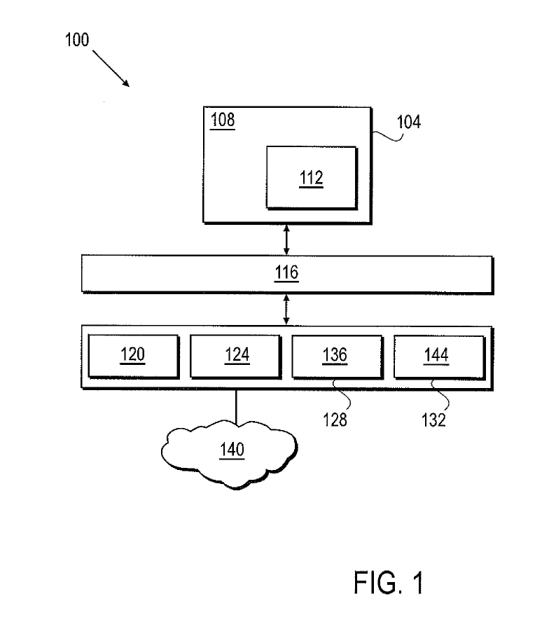

FIG. 1 schematically illustrates a computer system 100 that may operate as a server, a client device, database, etc., in accordance with various embodiments of the present invention. The system 100 may have an execution environment 104, which may be the domain of an executing operating system (OS) 108. The OS 108 may be a component configured to execute and control general operation of other components within the execution environment 104, such as a software component 112, subject to management by a management module 116. The management module 116 may arbitrate general component access to hardware resources such as one or more processor(s) 120, network interface controller 124, storage 128, and/or memory 132.

In some embodiments, the component 112 may be a supervisory-level component, e.g., a kernel component. In various embodiments, a kernel component may be services (e.g., loader, scheduler, memory manager, etc.), extensions/drivers (e.g., for a network card, a universal serial bus (USB) interface, a disk drive, etc.), or a service-driver hybrid (e.g., intrusion detectors to watch execution of code).

The processor(s) 120 may execute programming instructions of components of the system 100. The processor(s) 120 may be single and/or multiple-core processor(s), controller(s), application specific integrated circuit(s) (ASIC(s)), etc.

In an embodiment, storage 128 may represent non-volatile storage to store persistent content to be used for the execution of the components of the system 100, such as, but not limited to, operating system(s), program files, configuration files, etc. In an embodiment, storage 128 may include stored content 136, which may represent the persistent store of source content for the component 112. The persistent store of source content may include, e.g., executable code store that may have executable files and/or code segments, links to other routines (e.g., a call to a dynamic linked library (DLL)), a data segment, etc.

In various embodiments, storage 128 may include integrated and/or peripheral storage devices, such as, but not limited to, disks and associated drives (e.g., magnetic, optical), universal serial bus (USB) storage devices and associated ports, flash memory, ROM, non-volatile semiconductor devices, etc.

In various embodiments, storage 128 may be a storage resource that is physically part of the system 100 or it may be accessible by, but not necessarily, a part of the system 100. For example, the storage 128 may be accessed by the system 100 over a network 140 via the network interface controller 124. Additionally, multiple systems 100 may be operatively coupled to one another via network 140.

Upon a load request, e.g., from a loading agent of the OS 108, the management module 116 and/or the OS 108 may load the stored content 136 from storage 128 into memory 132 as active content 144 for operation of the component 112 in the execution environment 104.

In various embodiments, the memory 132 may be volatile storage to provide active content for operation of components on the system 100. In various embodiments, the memory 132 may include RAM, dynamic RAM (DRAM), static RAM (SRAM), synchronous DRAM (SDRAM), dual-data rate RAM (DDRRAM), etc.

In some embodiments the memory 132 may organize content stored therein into a number of groups of memory locations. These organizational groups, which may be fixed and/or variable sized, may facilitate virtual memory management. The groups of memory locations may be pages, segments, or a combination thereof.

As used herein, the term “component” is intended to refer to programming logic and associated data that may be employed to obtain a desired outcome. The term component may be synonymous with “module” or “agent” and may refer to programming logic that may be embodied in hardware or firmware, or in a collection of software instructions, possibly having entry and exit points, written in a programming language, such as, for example, C++, Intel Architecture 32 bit (IA-32) executable code, etc.

A software component may be compiled and linked into an executable program, or installed in a dynamic link library, or may be written in an interpretive language such as BASIC. It will be appreciated that software components may be callable from other components or from themselves, and/or may be invoked in response to detected events or interrupts. Software instructions may be provided in a machine accessible medium, which when accessed, may result in a machine performing operations or executions described in conjunction with components of embodiments of the present invention. Machine accessible medium may be firmware, e.g., an electrically erasable programmable read-only memory (EEPROM), or other recordable/non-recordable medium, e.g., read-only memory (ROM), random access memory (RAM), magnetic disk storage, optical disk storage, etc. It will be further appreciated that hardware components may be comprised of connected logic units, such as gates and flip-flops, and/or may be comprised of programmable units, such as programmable gate arrays or processors. In some embodiments, the components described herein are implemented as software modules, but nonetheless may be represented in hardware or firmware. Furthermore, although only a given number of discrete software/hardware components may be illustrated and/or described, such components may nonetheless be represented by additional components or fewer components without departing from the spirit and scope of embodiments of the invention.

In embodiments of the present invention, an article of manufacture may be employed to implement one or more methods as disclosed herein. For example, in exemplary embodiments, an article of manufacture may comprise a storage medium and a plurality of programming instructions stored in the storage medium and adapted to program an apparatus to enable the apparatus to request from a proxy server one or more location restriction(s) to modify one or more user preference(s). In various ones of these embodiments, programming instructions may be adapted to modify one or more user preferences to subject the one or more user preferences to one or more location restrictions. In various embodiments, article of manufacture may be employed to implement one or more methods as disclosed herein in one or more client devices. In various embodiments, programming instructions may be adapted to implement a browser, and in various ones of these embodiments, a browser may be adapted to allow a user to display information related to a network access. In an exemplary embodiment, programming instructions may be adapted to implement a browser on a client device.

Examples of client devices include a desktop computer, a laptop computer, a handheld computer, a tablet computer, a cellular telephone, a personal digital assistant (PDA), an audio and/or video player (e.g., an MP3 player or a DVD player), a gaming device, a navigation device (e.g., a GPS device), and/or other suitable fixed, portable, or mobile electronic devices.

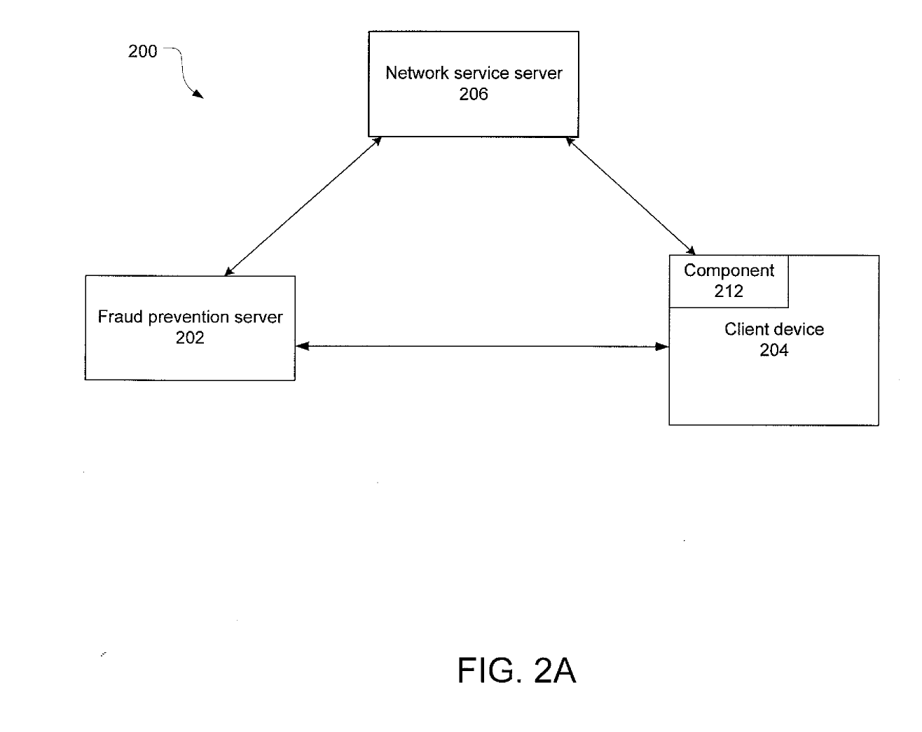

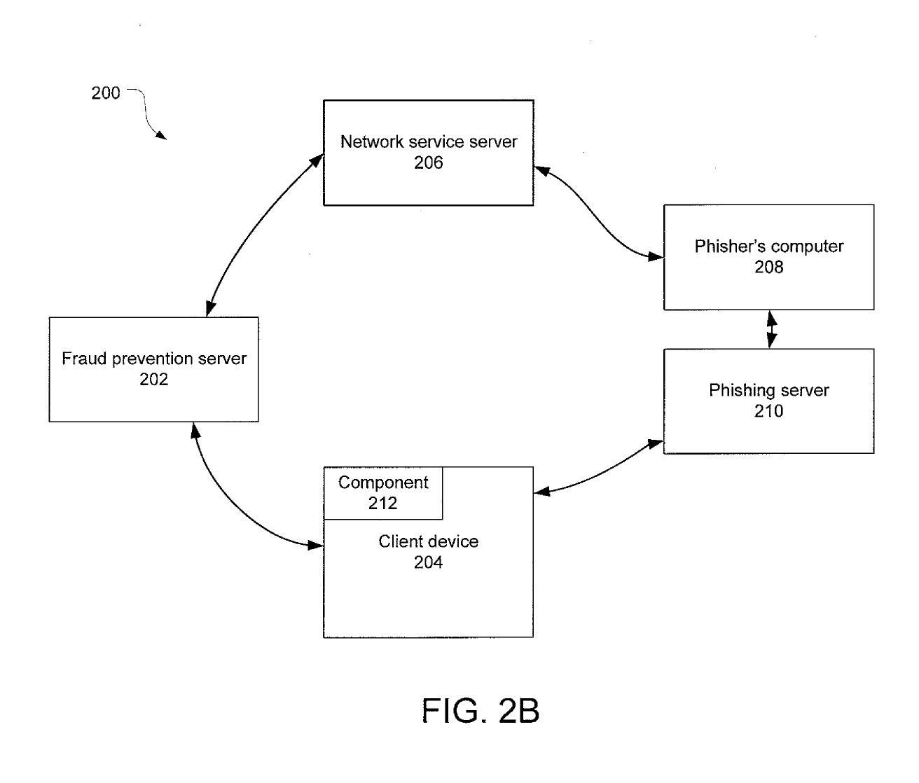

Referring to FIGS. 2A and 2B, a network 200 is illustrated that includes a fraud prevention server 202 that serves as an anti-phishing server, a client device 204 and a network service server 206, i.e., a server that provides some type of service and/or content to the client device 204. FIG. 2A illustrates an example of a desired arrangement for computer network 200.

FIG. 2B illustrates computer 200 and further includes a phisher's computer 208 and a phisher's webserver 210. Thus, FIG. 2B illustrates an example of an undesirable arrangement for computer network 200.

Those skilled in the art will understand that multiple client devices 204 may be communicatively coupled to one or more network service servers 206 to access its content and/or services. Client devices may be coupled to the network service and anti-phishing servers via one or more networks, such as, for example, the Internet, which may be one or more wireless and/or wireline based local and/or wide area networks (LANs and/or WANS). FIGS. 2A and 2B are illustrated as they are for simplicity and clarity.

An application or component 212 is provided to client device 204 via either fraud prevention server 202 or network service server 206, which may obtain the application 212 from fraud prevention server 202. The component 212 facilitates various aspects of the present invention as will be further discussed herein.

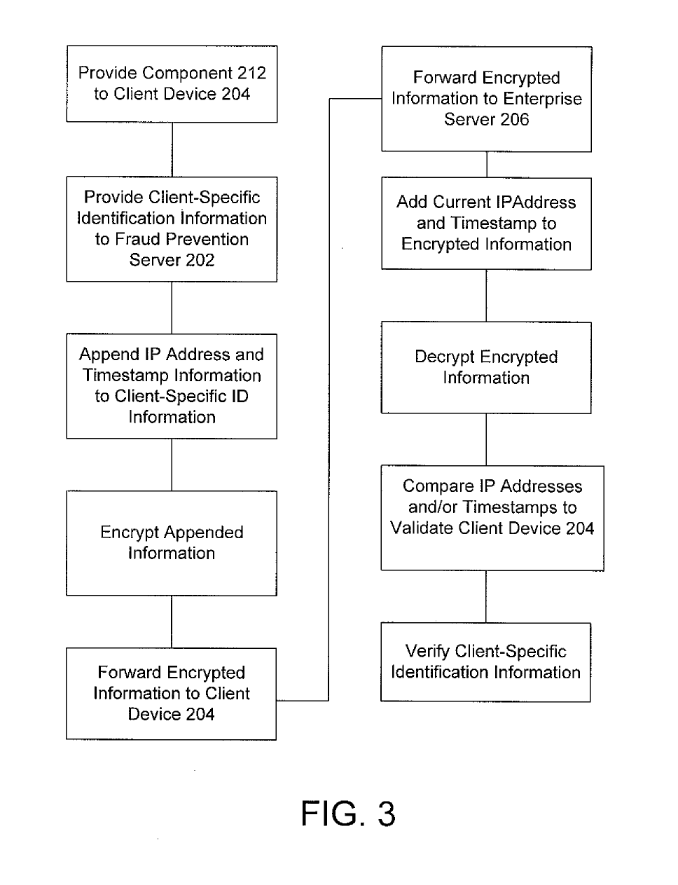

Thus, referring to FIGS. 2A, 2B and 3, in accordance with various embodiments of the present invention, a component 212 such as, for example, an ActiveX control, or a browser plug-in containing the client code needed for such a protocol, is downloaded to the client device 204. The network service server 206 is aware or otherwise expects that the client device 204 has the component 212. Thus, when the client device 204 attempts to login to the network service server 202, the web page at the network service server 206 for the login calls the component 212.

In accordance with various embodiments of the present invention, the component 212 in turn calls to the fraud prevention server 202 and passes it device-specific information that may be used to accurately recognize the client device 204. The information passed to the fraud prevention server 202 may be encrypted and/or encoded, in accordance with various embodiments, and in such instances, the fraud prevention server 202 decrypts and/or decodes the information. The call to the fraud prevention server 202 may be asynchronous (such as, for example, via an XML HTTP request call) or it may be synchronous.

In response, the fraud prevention server 202 appends a current timestamp and/or the Internet protocol (IP) address of the client device 204 to the device information sent by the client device 204. In accordance with various embodiments, the appended device information is encrypted using a session key. In accordance with various embodiments, the fraud prevention server 202 encrypts the session key with a public key belonging to the network service server/web site 206. Alternatively, the fraud prevention server 202 encrypts the session key with a public key belonging to a security service provider (not illustrated). The fraud prevention server 202 then sends the encrypted appended device information back to the client device 204.

In accordance with other embodiments, when the client device 204 initially receives the component 212 from fraud prevention server 202, it may also include the IP address and/or a timestamp as either encrypted or non-encrypted data for use in communicating with the network service server 206 initially. If the data is non-encrypted, the client device 204 may encrypt the data prior to forwarding it to the network service server 206. In accordance with various embodiments, the client device may call to the fraud prevention server 202, which will reply with an echo communication that includes the IP address and/or current timestamp. The client device may then append the IP address and current timestamp to a communication, such as the device specific-identification information, and encrypt the communication, which it may then forward to the network service server 206. As a further example, the client device 204 may request an update of a previous device-specific information communication such that it includes current IP address information and/or a current timestamp, which the fraud prevention server may echo back to the client device 204. Either the fraud prevention server 202 or the client device may encrypt the updated communication.

In accordance with various embodiments of the present invention, the client device 204 embeds the encrypted appended device information in a web page or otherwise sends it back to the network service server 206. The network service server 206 appends the client device's IP address and the current timestamp to the received data. Thus, there are now two timestamps and two IP addresses, one securely encrypted inside the body of the data, and one outside. The network service server 206 then either decrypts the data locally or uses a security service provider (depending on who has the private key) and compares the IP addresses. If the IP addresses do not match (or, if dynamic proxies are used, do not both belong to ranges belonging to the Internet service provider of the client device 204), it suggests that there may be a man-in-the-middle phisher. If the IP addresses match, and the client device 204 is recognized from the device-specific information, and thus is known to be associated with that particular login account, the login may proceed with just an account name and password. If the client device 204 is not recognized or is not approved for use with that particular login account, the network service server 206 may deny login for the client device 204 and/or may request that the user of client device 204 contact a customer service department of the network service server 206 via telephone or some other out-of-band method. The timestamps may also be compared in addition to, or in place of the IP address comparison, and if there is a substantial difference between the two, this may also suggest a man-in-the-middle phisher.

Thus, those skilled in the art will understand that if a phishing web server 210 has captured the user login, password and valid encrypted appended device-specific information, then the phisher may use the captured login, password and encrypted data to attempt to login to the network service server 206 masquerading as an authorized user. However, in such an instance, the IP address of the man-in-the-middle phisher will not match the IP address that is encrypted in the encrypted appended device-specific information. Thus, the login could be denied by the network service server 206 and/or the network service server 206 may request that the user of client device 204 contact a customer service department of the network service server 206 via telephone or some other out-of-band method. Additionally, if the timestamp inside the appended device-specific information is off by more than a short time period, the login may be denied since this indicates extra time having passed between the encryption and the arrival of the encrypted device-specific information at the network service server 206, thereby indicating the possibility of a man-in-the-middle phisher. The network service server 206 may request that the user of client device 204 contact a customer service department of the network service server 206 via telephone or some other out-of-band method.

If the man-in-the-middle phisher downloads the component 212 and sends its own device information, the IP addresses will match, but the device-specific information of the phisher's computer 208 will not match device-specific information for a client device 204 that is approved for use with that particular login account. Thus, the network service server 206 may challenge the man-in-the-middle phisher. Alternatively, or additionally, the network service server may send an out-of-band, one-time password, thereby alerting a user of client device 204 that they have been attacked by a man-in-the-middle phisher.

Those skilled in the art will also understand that, in accordance with the present invention, the phishing web server 210 may act as a proxy such that all of the client device's requests are dynamically forwarded to the network service server 206, and the network service server 206 responses are forwarded to the client device 204. However, in such an instance, the IP address inside the encrypted appended device-specific information will not match the IP address seen by the network service server 206, and/or the device data will not match a client device 204 approved for use with the particular login account. Thus, the network service server 206 may challenge the login if the proxy calls the fraud prevention server 202 directly to get the encrypted appended device-specific information.

While it is preferred that the fraud prevention server 202 and the network service server 206 are separate servers, those skilled in the art will understand that the network service server 206 and fraud prevention server 202 may be the same server. In such an instance, they may be partitioned and arranged as separate virtual servers if desired. Likewise, the phisher's computer 208 and the phishing server 210 may be a single apparatus.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
receiving device-specific information from a client device at a fraud prevention server;
appending at least one of an internet protocol (IP) address and/or a timestamp to the device-specific information; and
forwarding the appended device-specific information back to the client device for providing to a network service server for use by the network service server to facilitate recognition of the client device via at least one of the IP address and/or the timestamp.

2. The method of claim 1, further comprising appending both an IP address and the timestamp to the device-specific information.

3. The method of claim 1, further comprising encrypting the appended device-specific information prior to forwarding the appended device-specific information back to the client device.

4. The method of claim 1, further comprising at least one of decoding and/or decrypting the device-specific information prior to appending the device-specific information.

5. The method of claim 1, wherein the network service server provides a component to the client device for communicating with the fraud prevention server.

6. The method of claim 5, wherein the fraud prevention server provides the component to the network service server.

7. The method of claim 1, wherein the fraud prevention server provides a component to the client device for communicating with the fraud prevention server.

8. A fraud prevention server comprising:
a processor; and
logic to be operated by the processor to:
receive device-specific information from a client device;
append at least one of an internet protocol (IP) address and/or a timestamp to the device-specific information; and
forward the appended device-specific information back to the client device for providing to a network service server for use by the network service server to facilitate recognition of the client device via at least one of the IP address and/or the timestamp.

9. The fraud prevention server of claim 8, wherein the logic is further to append both an IP address and the timestamp.

10. The fraud prevention server of claim 8, wherein the logic is further to encrypt the appended device-specific information prior to forwarding the appended device-specific information back to the client device.

11. The fraud prevention server of claim 8, wherein the logic is further to at least one of decode and/or decrypt the appended device-specific information prior to appending the device-specific information with the IP address and/or the timestamp.

12. The fraud prevention server of claim 8, wherein the logic is further to provide a component to the network service server to provide to the client device.

13. The fraud prevention server of claim 8, wherein the logic is further to provide a component to the client device for communicating with the fraud prevention server.

14. An article of manufacture comprising:
a storage medium; and
a plurality of programming instructions stored on the storage medium and configured to program a server to:
receive device-specific information from a client device;
append at least one of an internet protocol (IP) address and/or a timestamp to the device-specific information; and
forward the appended device-specific information back to the client device for providing to a network service server for use by the network service server to facilitate recognition of the client device via at least one of the IP address and/or the timestamp.

15. The article of manufacture of claim 14, wherein the programming instructions are further configured to program the server to append both an IP address and the timestamp.

16. The article of manufacture of claim 14, wherein the programming instructions are further configured to program the server to encrypt the appended device-specific information prior to forwarding the appended device-specific information back to the client device.

17. The article of manufacture of claim 14, wherein the programming instructions are further configured to program the server to at least one of decode and/or decrypt the appended device-specific information prior to appending the device-specific information.

18. The article of manufacture of claim 14, wherein the programming instructions are further configured to program the server to provide a component to the network service server to provide to the client device.

19. The article of manufacture of claim 14, wherein the programming instructions are further configured to program the server to provide a component to the client device for communicating with the fraud prevention server.

20. A method comprising:
receiving device-specific information from a client device at a server;
appending at least one of an internet protocol (IP) address and/or a timestamp to the device-specific information; and
forwarding the appended device-specific information back to the client device for providing to the server in a subsequent communication from the client device for use by the server to facilitate recognition of the client device via at least one of the IP address and/or the timestamp.

21. The method of claim 20, further comprising appending both an IP address and the timestamp to the device-specific information.

22. The method of claim 20, further comprising encrypting the appended device-specific information prior to forwarding the appended information back to the client device.

23. The method of claim 22, further comprising decrypting the appended information upon receipt of the subsequent communication.

24. The method of claim 20, further comprising at least one of decoding and/or decrypting the device-specific information prior to appending the device-specific information.
